(19) United States
(12) Patent Application Publication
(10) Pub. No.: US 2011/0145563 A1
(43) Pub. Date: Jun. 16, 2011

(54) SECURED FILE-BASED APPLICATION PROGRAMMING INTERFACE

(76) Inventors: Michael Thomas Kain, Collegeville, PA (US); Owen Akio Nagasawa, Trabuco Canyon, CA (US); Mark Steven Brandt, Laguna Beach, CA (US); Andrew David Milligan, Milton Kenyes (GB)

(21) Appl. No.: 12/636,810

(22) Filed: Dec. 14, 2009

(51) Int. Cl. H04L 29/06

(52) U.S. Cl. 713/151

(57) ABSTRACT

Data communication security systems and methods are disclosed. One such system includes a network interface configured for transport layer protocol communications at a communication port. The network interface includes a security module communicatively connected to a transport layer data path. The system further includes a file-based application programming interface defining a plurality of attributes of the network interface and including at least one attribute associated with data encryption managed by the security module and accessible for use in logical I/O operations.

### TECHNICAL FIELD

The present disclosure is related to a file-based application programming interface. In particular, the present disclosure relates to encryption-secured, file-based API useable at a communication interface.

### BACKGROUND

A file-based application programming interface (API) can be used to expose access to hardware resources in a computing system or network of computing systems. Typically, such an API exposes the hardware resources and directs data transactions via file-based commands, such as open, close, read, and write operations. For example a file-based command can be directed toward a “port file” which is a file-based view of a communication port. Attributes are available for network resources in such file-based APIs, and can be specified through an attribute set retrievable using the API.

Transport Layer Security (TLS) and Secure Sockets Layer (SSL) are network security protocols for communications over networks such as the Internet. TLS and SSL encrypt the segments of network connections at the Transport Layer end-to-end. These protocols are typically implemented on behalf of application layer protocols (such as HTTP, FTP, SMTP, and other protocols), by encapsulating the application specific protocols.

Resources exposed via a file-based API, particularly network resources, can be secured by use of TLS or SSL modules operating on data in the transport layer (e.g., TCP) data path. Currently, file-based APIs have no way of allowing an application to use SSL/TLS security above the current native service provided.

To illustrate this shortcoming in existing file-based API systems, an existing logical arrangement of a data communications interface 10 is shown in FIG. 1. In that arrangement, a file-based interface 12 and a socket-based interface 14 are each interfaced with a TCP block 16. Within the TCP block 16, a network file handler 18 is logically connected to the file-based interface 12, and a security block 20 is logically connected to the socket handler 14. The security block 20 is interfaced to a security protocol engine 22 within a TCP/IP security block 24 which calls the cryptography API. Each of the security block 20 and the network file handler 18 are independently connected to a TCP data path 26.

In use, the file-based interface 12 directs logical I/O commands within TCP data path 26 via the network file handler 18 of TCP block 16. Similarly, socket-based interface 14 interfaces with security block 20 of the TCP/IP block 16 to transmit commands regarding native encryption included within the TCP block for use on the TCP data path 26. Notably, security is handled separately from the logical I/O operations within the TCP block 16, and is only accessible to socket-based interface 14, which is not accessible to a user via a file-based API 30 associated with the file-based interface 12. Rather, security within the TCP block 16 is typically only provided via a socket-based API 40, associated with the socket-based interface 14. Therefore, current designs do not provide access to SSL/TLS security controls for logical I/O operations above the current native service provided.

For these and other reasons, improvements are desirable.

### SUMMARY

In accordance with the following disclosure, the above and other problems are addressed by the following:

In a first aspect, a data communication security system is disclosed. The system includes a network interface configured for transport layer protocol communications at a communication port. The network interface includes a security module communicatively connected to a transport layer data path. The system further includes a file-based application programming interface defining a plurality of attributes of the network interface and including at least one attribute associated with data encryption managed by the security module and accessible for use in logical I/O operations.

In a second aspect, a method of securing data at a communication port of a computing system. The method includes issuing an open command to a communication port, the open command included in a file-based application programming interface defining a plurality of attributes including at least one attribute associated with data encryption. The method also includes setting at least one attribute of the communication port associated with data encryption at the communication port. The method further includes issuing a write command to the communication port, the write command included in the file-based application programming interface, wherein data associated with the write command is encrypted based on the at least one attribute specified.

In a third aspect, a communication interface for a computing system includes a network interface and a file-based application programming interface. The network interface, for transport layer protocol communications at a communication port, includes a data path, a logical I/O control module communicatively connected to the data path, and a security module communicatively connected to the data path, the security module also communicatively connected to the logical I/O control module. The file-based application programming interface defines a plurality of attributes of the network interface, the plurality of attributes including at least one attribute associated with data encryption managed by the security module and accessible for use in logical I/O operations, the at least one attribute defining at least one of an implicit security mode or an explicit security mode.

### BRIEF DESCRIPTION OF THE DRAWINGS

FIG. 1 is a block diagram of a prior art data communications interface;

FIG. 2 is a logical diagram of a network in which aspects of the present disclosure can be implemented;

FIG. 3 is a block diagram of a data communications interface according to a possible embodiment of the present disclosure;

FIG. 4 is an object diagram illustrating usage of a data communications structure by a secure data control system, according to a possible embodiment of the present disclosure;

FIG. 5 is an object diagram illustrating usage of a data communications structure in association with a logical I/O operation, according to a possible embodiment of the present disclosure;

FIG. 6 is a flowchart of a method of instantiation and use of a communication interface using a security-enabled file-based API, according to a possible embodiment of the present disclosure; and

FIG. 7 is a block diagram illustrating example physical components of an electronic computing device useable to implement the various methods and systems described herein.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for providing security at a communication port, such as by extending a file-based application programming interface to allow encryption settings to be accessed and governed within the API. Previously, as illustrated above, previously-encrypted data is passed to the port resource of the file-based API for communication at the port if additional encryption/security was desired. The present disclosure therefore provides a straightforward method for application programs to write data to a communication port using that port's file-based interface (i.e., a “port file” associated with the communication port) that includes viewable, settable attributes related to encryption/decryption performed at the port.

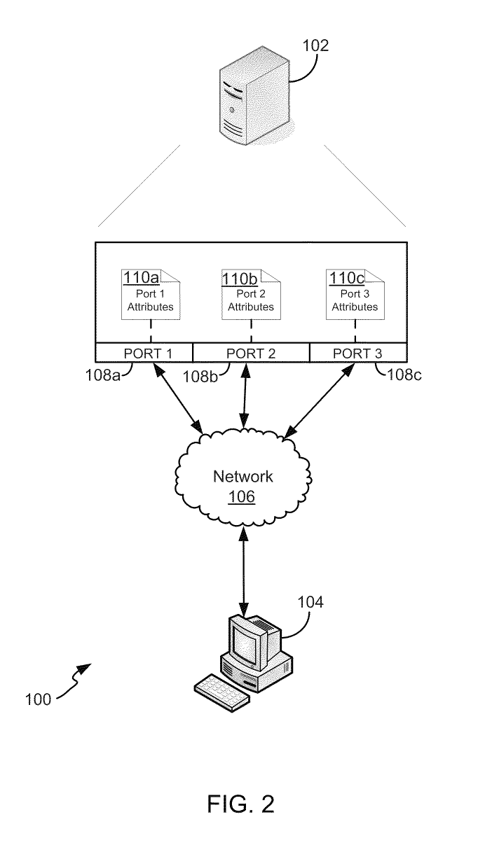

Referring now to FIG. 2, a logical diagram of a network 100 is shown in which aspects of the present disclosure can be implemented. The network 100 includes a plurality of computing systems, including a server system 102 and a client system 104. The systems can be communicatively connected, for example by way of a network connection 106. The network connection can encompass any of a number of media and communications protocols, and can be, for example, one or more WAN, SAN, LAN, or other Internet-type connections.

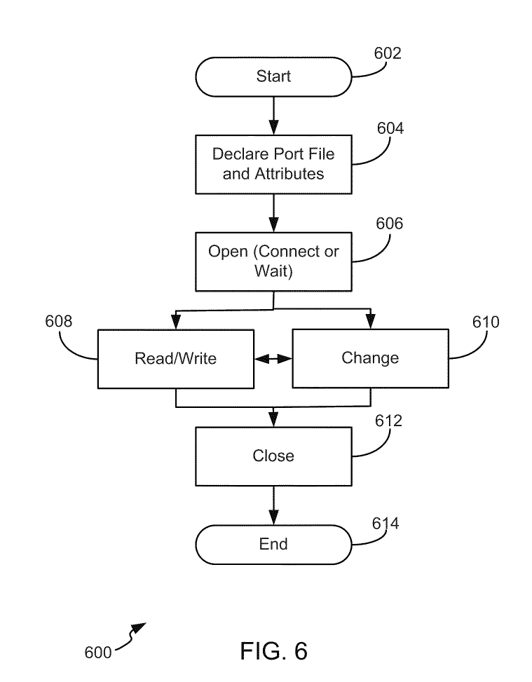

The computing systems 102, 104 can be any of a number of types of computing systems; an example of a computing system suitable within the context of the present disclosure is provided below in conjunction with FIG. 6. Additionally, in the embodiment shown, server system 102 includes a plurality of individually-addressable ports 108a-c. The server system 102 can selectively activate any of the addressable portions 108a-c for data exchange using an interface for those ports.

In embodiments described herein, the server system uses a file-based programming interface to enable, disable, read, write, and set attributes for ports 108a-c. In such embodiments, a user of the server system 102 can use logical port files 110a-c to view and access various features of ports 108a-c. For example, a user can read various attributes from the files 110a-c which correspond to features of the ports; a user can also issue commands to open or close the port file, resulting in enabling/disabling of the ports. The user (e.g., application) can also read/write to the port files, which corresponds to receiving or sending data at the ports. In an example embodiment, the ClearPath MCP software provided by Unisys Corporation of Blue Bell, Pa., supports use of port files for access and control of the individually-addressable ports 108a-c.

Additionally, communications between the server system 102 and the computing system 104 can be secured, for example by using Secure Socket Layer (SSL) or Transport Layer Security (TLS), in which a certificate is provided by the server system 102 to the computing system 104 for validation (and optionally vice versa). Once security attributes, including ciphers and certificates to be used, is negotiated, encrypted communication between the systems can commence.

Although server system 102 is illustrated as having three communication ports 108a-c, any number of ports could be provided on any of a number of different server systems within a network, accessible to a number of different computing systems. The particular architecture of the network is largely a matter of design choice.

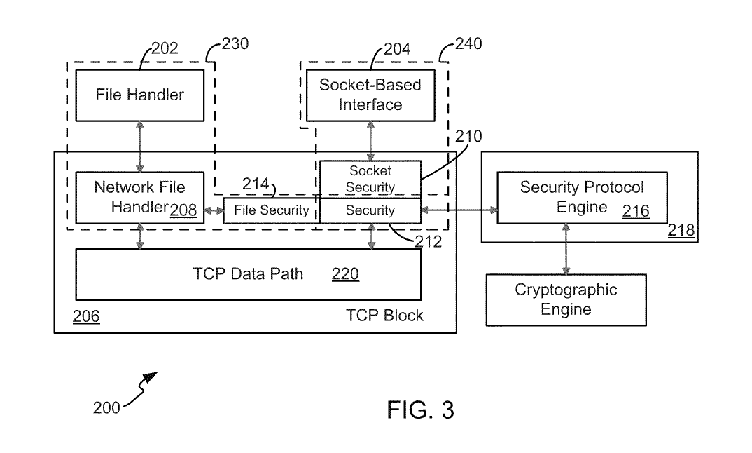

FIG. 3 is a block diagram of a data communications interface 200 according to a possible embodiment of the present disclosure. The data communications interface 200 of FIG. 3 illustrates the logical arrangement of the interface as it is modified by having a number of security and encryption features exposed as attributes for user-access for logical I/O operations.

In the embodiment shown, the data communications interface 200 includes a file-based interface 202 and a socket-based interface 204, each interfaced with modules within a transport layer communication module, e.g., TCP/IP block 206. Specifically, the file-based interface 202 is communicatively interfaced with a network file handler 208, and the socket-based interface 204 is communicatively interfaced with a socket security module 210. The socket security module 210 is operably interconnected with a security module 212 and a file security module 214, operation of each of which is described in further detail below. The security module 212 is communicatively connected to a security protocol engine 216 in a security block 218 (which can also connect to external systems via a different functional block, e.g., the cryptographic engine as shown) The security module 212, and the network file handler 208 are also communicatively connected to TCP data path 220.

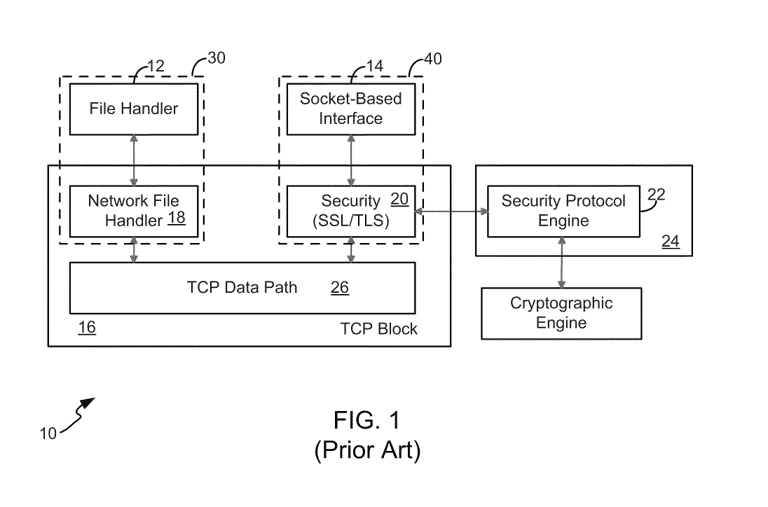

As compared to the interface 10 of FIG. 1, it can be seen that the various security modules (socket security module 210, security module 212, and file security module 214) separate the previous security module into subsections, and provide an interface to security commands from the file handler 208. This allows the file-based interface 202 to transmit logical I/O operations to the TCP/IP block 206 and dictate security settings to that block, allowing the TCP/IP block to manage the security operations transparently from the perspective of the file-based interface (to which the file-based API is published).

In general, the socket security module 210 provides security for operations received from the socket-based interface 204, and the file security module 214 provides security for operations received from the file-based interface 202 via the network file handler 208. The security module 212 connects to the security protocol engine 216 to obtain security (e.g., encryption or decryption) of data objects to be placed into or received from the TCP data path 220.

Through use of the interface 200, the security modules are divided into two “halves”—one half that deals with the SSL data, and one that deals with the “user” (either the proprietary or logical I/O user). This provides an advantage by allowing the security module code to be more generic and remove the proprietary API code from the core SSL module. This design also abstracts the protocol engine out of the API (so that it can be specified), enabling additional protocol engines to be developed.

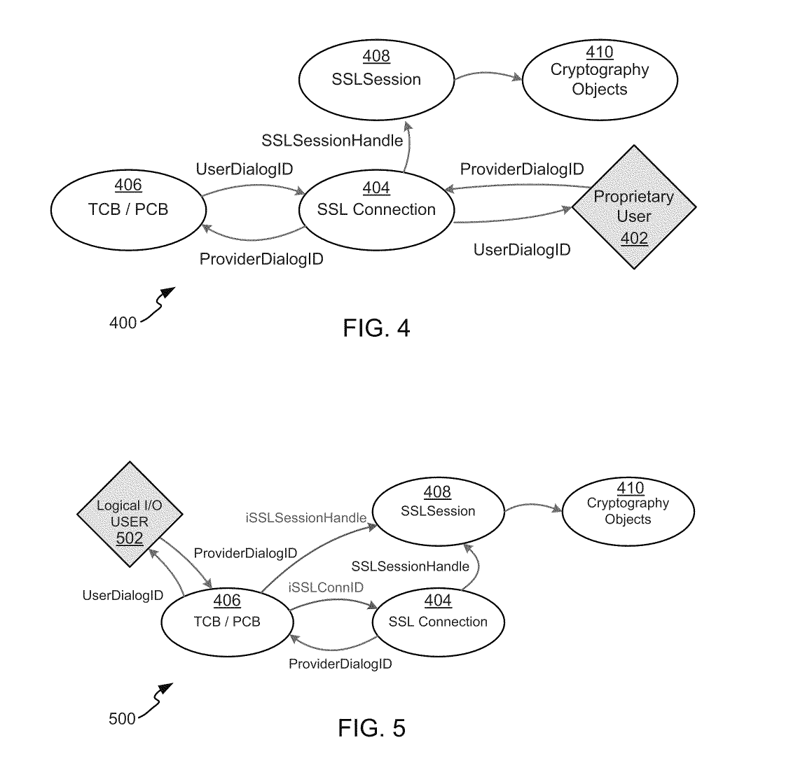

From the perspective of the file-based interface 202, the TCP/IP block 206 publishes a file-based API 230, separate from a socket-based API 240, and which allows enabling, disabling, performing read/write operations, or accessing attributes of communication port with which the interface 200 is associated. Various attributes can be specified; a number of these are described below, and operation thereof is illustrated in the examples provided in FIGS. 4-5, below.

One possible attribute specifies whether the connection or dialog between a port and a computing system accessing that port is either secure or unsecure.

Such an attribute, e.g. called “SSLSECUREMODE” in the example below, can be modified to “turn on” or “turn off” the security associated with a port for the logical I/O operations addressed to that port.

A second possible attribute allows a user to set the type of security to be used for logical I/O operations. This second attribute could, in various embodiments, allow a user to set an implicit or explicit security mode. In an implicit security mode, a specific port number can be used in association with the communication port to dictate that security is used, similar to use of HTTPS and specific secured ports. In contrast, the explicit security mode allows setting of a parameter (e.g., the enabling parameter described in the previous paragraph), to enable or disable encryption at a communication port (similar to use by FTPS).

Additional parameters can be exposed to a user for use in logical I/O operations using the file-based API 230 as described herein. A key container attribute specifies the particular cryptographic key and certificate (e.g., X.509 certificate for SSL) to be used during handshake operations associated with a port file and associated communication port, e.g., called SSLKEYCONTAINER in the example below. A certificate request attribute indicates whether to request a certificate from the far end of the communication link (e.g. a remote computing system), e.g., for two-way authentication. Additionally, a root store attribute indicated which trusted certificate store should be used for authentication during handshake operations.

Additionally, cipher attribute indicates which ciphers to be used during handshake operations. The cipher attribute can include a plurality of selectable strength levels. A negotiated cipher attribute indicates which cipher suite was negotiated, and can indicate any one of a number of ciphers using various key exchange algorithms, security techniques, and digest algorithms.

A maximum version attribute indicates the version or type of security protocol to be used. Example versions indicated by the version attribute can include TLS or SSL versions. An error attribute can include a variety of error codes readable by an application program to monitor security.

Additional attributes can be included into the port file structure, and can be made accessible to a user of a communication port. Furthermore, one or more of the attributes can be set or read during an open or close operation executed on a port file. For example, to incorporate security into a server system using the file-based API described above, example code could read as follows:

OBJECT.SSLSECUREMODE:=VALUE(SECURE);

REPLACE OBJECT.SSLKEYCONTAINER BY “OBJECT KEY1.”;

Similarly, example client code could be added to enable secure communications with a particular port of a system as follows:

OBJECT.SSLSECUREMODE:=VALUE(SECURE);

The above code lines would define the first attribute described above (“SSLSECUREMODE”) to “SECURE” indicating that encryption is enabled and allowing instantiation of a handshaking process to establish a secure connection between the port identified by the object and a remote system. Additionally, although the attributes are described as assignable via the file-based API 230, one or more of the attributes may be associated with preassigned values, and therefore do not require assignment at the time a communication port is opened.

Referring now to FIGS. 4-5, example object diagrams are provided for instantiation of encryption in a manner consistent with and abstractable by the file-based API described herein. FIGS. 4-5 define example embodiments of operation of the overall architecture of a data communication interface as illustrated in FIG. 3, above.

FIG. 4 is an object diagram 400 illustrating usage of a data communications structure by a proprietary module, according to a possible embodiment of the present disclosure. Overall, the object diagram 400 corresponds to operation on proprietary data as indicated in the network interface of FIG. 3, above. The socket module 402 indicates that a connection is instantiated by the socket user (e.g., socket-based interface 204 of FIG. 2). An encryption connection structure 404 (illustrated as “SSL Connection”) initializes an SSL connection for an operation initiated by the socket module 402. The SSL connection structure 404 is instantiated using a provider dialog identifier to track the request with which SSL is associated, and a user identifier is returned to the socket module 402. The TCB/PCB structure 406 is then created at the request of the SSL connection structure 404 (e.g., at socket security module 210). The TCB/PCB structure 406 receives the provider dialog identifier from the SSL connection structure 404 and returns a user dialog identifier to the SSL connection structure. The SSL connection structure 404 also spawns an SSL session 408 (e.g., at security module 212 and security protocol engine 216), which creates cryptography objects 410 for use in securing data as required for the socket-based data path.

Referring now to FIG. 5, an example object diagram 500 is shown that accommodates connection of the file-based interface to allow security of logical I/O operations using a file-based API as explained herein. In this embodiment, a file interface 502 (e.g., the network file handler 208 described in FIG. 3, above) creates a TCB/PCB structure 406. The TCB/PCB structure 406 supports data reads and writes directly from internal variables. If SSL is enabled, an existing SSL connection structure 404 transmits a session handle to an SSL session 408 (e.g., via file security module 214), which creates the cryptography objects 410 as in FIG. 4, above. TCB/PCB 406 is additionally linked back to the SSL connection structure 404 by a connection identifier and to the SSL session 408 by a session handle to allow the TCB/PCB 406 to track security of logical I/O operations.

Now referring to FIG. 6, a flowchart of an example method 600 of operation of a file-based API as discussed herein is provided. The method is instantiated at a start operation 602, which corresponds to publishing or otherwise making the API available to external applications wishing to execute file-based I/O operations on a computing system that includes that API. Operational flow proceeds to a declaration module 604, which corresponds to declaring a new connection using a data interface such as described herein. The declaration module can be an open command associated with a particular port file to allow I/O operations using the file-based API. The declaration can include any of a number of instantiations of variables relating to security. These can include, at a most basic level, a statement as to whether encryption should be enabled or disabled. Optionally, other encryption-related variables could be set as well, relating to the particular mode (e.g., implicit or explicit), or other encryption options allowed via the file-based API as explained above.

An open module 606 corresponds to opening a port file and optionally waiting for the port to allow communication. During the open module 606, various objects can be created for managing and handling I/O operations received via the file-based API, e.g., as illustrated and described in connection with FIG. 5, above.

An I/O operation module 608 corresponds to operations occurring while the port is open, and includes read and write operations directed to the port file, which are in turn handled at the communication interfaces of the associated computing system. I/O operations can include read or write operations directed to a port file, which are routed through the security-enabled file-based API described herein (e.g., via blocks 202, 208, 214, 212, to block 220).

Optionally, a security change module 610 can be used in conjunction with the I/O operation module, such as when certain security settings can be altered after the port file and associated port is opened. For example, a system using explicit mode encryption could allow a user (e.g., an application program) to selectively enable or disable encryption for different I/O operations associated with the port file. Other changes to the security parameters (or read/retrieve operations related to security parameters) could occur while the port is in use as well. A close module 612 corresponds to completed use of the port and associated port file by the user (e.g., the application program). An end operation 614 signifies completed use of the port by the user.

Additional operations can be incorporated into the method 600 as well, and are largely a matter of design choice based on implementation of the file-based API and the particular settings incorporated therein.

Using the above-described systems and interfaces, it can be seen that a number of advantages result from exposing port-specific security features to be visible to applications using a file-based API. For example, the file-based API allows simple programming adjustments by application developers to quickly incorporate security into server and client-side systems, while also allowing extensibility to customize the level of security provided (e.g., by adjusting the cipher or key used, or by adjusting the type of encryption enabled, e.g. from implicit to explicit security). The specific security operations are also separated from the applications accessing a communication port due to abstraction at the file-based API, thereby making the encryption and decryption of logical I/O operations opaque to and removed from those applications issuing I/O operation commands.

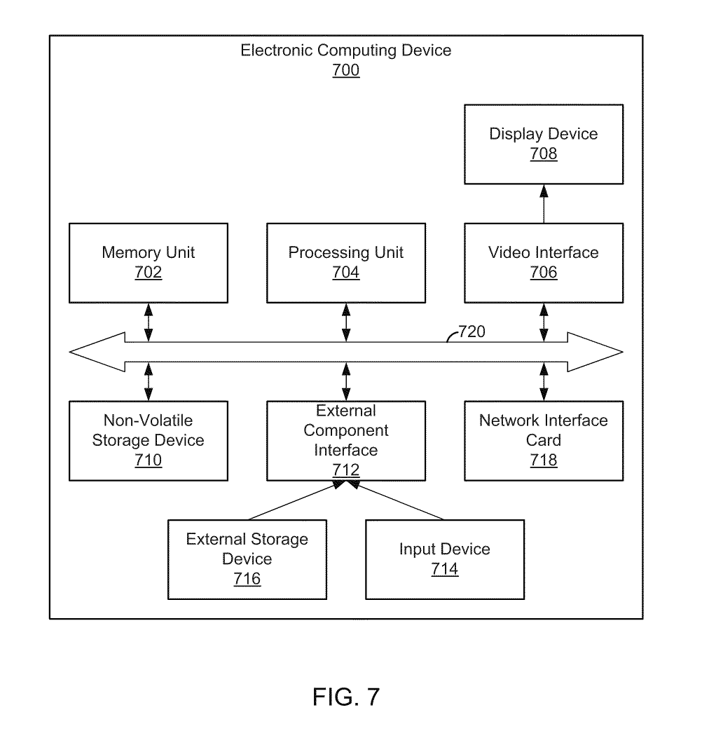

FIG. 7 is a block diagram illustrating example physical components of an electronic computing device 700, which can be used to execute the various operations described above, and can be any of a number of the devices described in FIG. 1 and including any of a number of types of communication interfaces as described herein. A computing device, such as electronic computing device 700, typically includes at least some form of computer-readable media. Computer readable media can be any available media that can be accessed by the electronic computing device 700. By way of example, and not limitation, computer-readable media might comprise computer storage media and communication media.

As illustrated in the example of FIG. 7, electronic computing device 700 comprises a memory unit 702. Memory unit 702 is a computer-readable data storage medium capable of storing data and/or instructions. Memory unit 702 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 700 comprises a processing unit 704. As mentioned above, a processing unit is a set of one or more physical electronic integrated circuits that are capable of executing instructions. In a first example, processing unit 704 may execute software instructions that cause electronic computing device 700 to provide specific functionality. In this first example, processing unit 704 may be implemented as one or more processing cores and/or as one or more separate microprocessors. For instance, in this first example, processing unit 704 may be implemented as one or more Intel Core 2 microprocessors. Processing unit 704 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 704 may be implemented as an ASIC that provides specific functionality. In a third example, processing unit 704 may provide specific functionality by using an ASIC and by executing software instructions.

Electronic computing device 700 also comprises a video interface 706. Video interface 706 enables electronic computing device 700 to output video information to a display device 708. Display device 708 may be a variety of different types of display devices. For instance, display device 708 may be a cathode-ray tube display, an LCD display panel, a plasma screen display panel, a touch-sensitive display panel, a LED array, or another type of display device.

In addition, electronic computing device 700 includes a non-volatile storage device 710. Non-volatile storage device 710 is a computer-readable data storage medium that is capable of storing data and/or instructions. Non-volatile storage device 710 may be a variety of different types of non-volatile storage devices. For example, non-volatile storage device 710 may be one or more hard disk drives, magnetic tape drives, CD-ROM drives, DVD-ROM drives, Blu-Ray disc drives, or other types of non-volatile storage devices.

Electronic computing device 700 also includes an external component interface 712 that enables electronic computing device 700 to communicate with external components. As illustrated in the example of FIG. 7, external component interface 712 enables electronic computing device 700 to communicate with an input device 714 and an external storage device 716. In one implementation of electronic computing device 700, external component interface 712 is a Universal Serial Bus (USB) interface. In other implementations of electronic computing device 700, electronic computing device 700 may include another type of interface that enables electronic computing device 700 to communicate with input devices and/or output devices. For instance, electronic computing device 700 may include a PS/2 interface. Input device 714 may be a variety of different types of devices including, but not limited to, keyboards, mice, trackballs, stylus input devices, touch pads, touch-sensitive display screens, or other types of input devices. External storage device 716 may be a variety of different types of computer-readable data storage media including magnetic tape, flash memory modules, magnetic disk drives, optical disc drives, and other computer-readable data storage media.

In the context of the electronic computing device 700, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 702, non-volatile storage device 710, or external storage device 716, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 700.

In addition, electronic computing device 700 includes a network interface card 718 that enables electronic computing device 700 to send data to and receive data from an electronic communication network. Network interface card 718 may be a variety of different types of network interface. For example, network interface card 718 may be an Ethernet interface, a token-ring network interface, a fiber optic network interface, a wireless network interface (e.g., WiFi, WiMax, etc.), or another type of network interface.

Electronic computing device 700 also includes a communications medium 720. Communications medium 720 facilitates communication among the various components of electronic computing device 700. Communications medium 720 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 720, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 700 includes several computer-readable data storage media (i.e., memory unit 702, non-volatile storage device 710, and external storage device 716). Together, these computer-readable storage media may constitute a single data storage system. As discussed above, a data storage system is a set of one or more computer-readable data storage mediums. This data storage system may store instructions executable by processing unit 704. Activities described in the above description may result from the execution of the instructions stored on this data storage system. Thus, when this description says that a particular logical module performs a particular activity, such a statement may be interpreted to mean that instructions of the logical module, when executed by processing unit 704, cause electronic computing device 700 to perform the activity. In other words, when this description says that a particular logical module performs a particular activity, a reader may interpret such a statement to mean that the instructions configure electronic computing device 700 such that electronic computing device 700 performs the particular activity.

One of ordinary skill in the art will recognize that additional components, peripheral devices, communications interconnections and similar additional functionality may also be included within the electronic computing device 700 without departing from the spirit and scope of the present invention as recited within the attached claims.

The above specification, examples and data provide a complete description of the manufacture and use of the composition of the invention. Since many embodiments of the invention can be made without departing from the spirit and scope of the invention, the invention resides in the claims hereinafter appended.

1. A data communication security system comprising:
a network interface configured for transport layer protocol communications at a communication port, the network interface including a security module communicatively connected to a transport layer data path;
a file-based application programming interface defining a plurality of attributes of the network interface and including at least one attribute associated with data encryption managed by the security module and accessible for use in logical I/O operations.

2. The data communication security system of claim 1, wherein the network interface includes a transport layer communication module.

3. The data communication security system of claim 2, wherein the transport layer communication module further includes a security module.

4. The data communication security system of claim 3, wherein the security module is communicatively connected to a file handler configured to control logical I/O operations.

5. The data communication security system of claim 1, wherein the security module provides encryption of data communicated on a TCP data path.

6. The data communication security system of claim 1, wherein at least one attribute specifies that the connection be secure or unsecure.

7. The data communication security system of claim 6, wherein the implicit encryption mode uses a predetermined communication port number to enable encryption at the network interface.

8. The data communication security system of claim 6, wherein the explicit encryption mode allows selectable enabling and disabling of encryption at the network interface.

9. The data communication security system of claim 1, wherein the data encryption includes at least one of an SSL encryption protocol or a TLS encryption protocol.

10. The data communication security system of claim 1, wherein the attribute associated with data encryption is accessible at a file handler.

11. The data communication security system of claim 10, wherein the attribute associated with data encryption can be set to provide encryption of data associated with logical I/O operations.

12. The data communication security system of claim 1, wherein the file-based application programming interface includes a plurality of attributes associated with data encryption and useable to configure encryption parameters used by the communication port.

13. A method of securing data at a communication port of a computing system, the method comprising:
issuing an open command to a communication port, the open command included in a file-based application programming interface defining a plurality of attributes including at least one attribute associated with data encryption;
setting at least one attribute of the communication port associated with data encryption at the communication port; and
issuing a write command to the communication port, the write command included in the file-based application programming interface, wherein data associated with the write command is encrypted based on the at least one attribute.

14. The method of claim 13, further comprising issuing a read command to the communication port, the read command included in the file-based application programming interface, and wherein the data received at the communication port is encrypted based on the at least one attribute.

15. The method of claim 13, wherein setting the at least one attribute to a predetermined value provides encryption of data associated with logical I/O operations

16. The method of claim 13, wherein the data encryption includes at least one of an SSL encryption protocol or a TLS encryption protocol.

17. The method of claim 13, wherein the file-based application programming interface includes a plurality of attributes associated with data encryption and useable to configure encryption parameters used by the communication port.

18. The method of claim 13, wherein the at least one attribute includes an attribute capable of selecting at least one of an implicit encryption mode or an explicit encryption mode.

19. The method of claim 13, wherein the at least one attribute denotes one or more ciphers to be used by the communication port.

20. A communication interface for a computing system comprising:
a network interface for transport layer protocol communications at a communication port, the network interface including a data path, a logical I/O control module communicatively connected to the data path, and a security module communicatively connected to the data path, the security module also communicatively connected to the logical I/O control module,
a file-based application programming interface defining a plurality of attributes of the network interface, the plurality of attributes including at least one attribute associated with data encryption managed by the security module and accessible for use in logical I/O operations, the at least one attribute defining at least one of an implicit encryption mode or an explicit encryption mode.
